(19) United States
(12) Patent Application Publication
(10) Pub. No.: US 2023/0294719 A1
(43) Pub. Date: Sep. 21, 2023

(54) INTELLIGENT ONE-PEDAL DRIVING SYSTEM

(71) Applicant: Faraday&Future Inc., Gardena, CA (US)

(72) Inventor: Geng Niu, Irvine, CA (US)

(21) Appl. No.: 17/700,131

(22) Filed: Mar. 21, 2022

(51) Int. Cl. B60W 50/08; B60W 30/18; B60W 10/08; B60W 10/184; G06V 20/58

(52) U.S. Cl. CPC B60W 50/08; B60W 10/08; B60W 10/184; B60W 30/18127; G06V 20/58; B60W 2540/10; B60W 2710/18

(57) ABSTRACT

A computer-implemented method of operating a vehicle. The method includes receiving a first signal from a pedal indicating no pressure is exerted on the pedal, the pedal, when pressed, configured to provide a manual input to an operation of the vehicle; determining whether the vehicle is within a threshold distance from an object ahead of the vehicle; if the distance between the vehicle and the object is within the threshold distance, engaging regenerative braking to reduce the speed of the vehicle; and if the distance between the vehicle and the object is above the threshold distance, preventing regenerative braking from being engaged to allow the vehicle to coast.

### FIELD

This relates generally to a driving system of a vehicle, and specifically relates to an intelligent one-pedal driving system that offers improved driving and ride experience for the vehicle occupants.

### BACKGROUND

Many existing electric (or electrified) vehicles (“EVs”) offer a one-pedal driving feature (“one-pedal driving”), which allows the driver to drive and stop the vehicle using only the accelerator pedal of the vehicle. When the driver fully released the accelerator pedal, the vehicle will automatically decelerate until a complete stop. One-pedal driving is possible due to the regenerative braking systems in electrified cars. When an EV brakes, the electric motor acts as a generator, converting kinetic energy from the vehicle’s forward motion into electricity. This electricity recharges the battery while the vehicle is braking. During this regenerative phase, the electromagnetic force is opposite to rotating direction and creates a braking force. This added driveline friction slows the vehicle down. The one-peal driving system can, at least in some instances, eliminate the need for the driver to engage the braking pedal as would be typically needed to slow down and/or stop the vehicle, thereby simplifying the driving experience.

Nevertheless, to cruise on the highway, the driver always needs to be applying the accelerator pedal to maintain the vehicle speed without engaging cruise control. If the driver releases the accelerator pedal, the vehicle will automatically enter a regeneration mode that would slow down the vehicle using the force from regenerative braking. This deceleration can be abrupt, resulting in an uncomfortable ride for the vehicle occupants.

### SUMMARY

In one aspect of the disclosure, a computer-implemented method of operating a vehicle is disclosed. The method includes receiving a first signal from a pedal indicating no pressure is exerted on the pedal, the pedal, when pressed, configured to increase a speed of the vehicle; determining whether the vehicle is within a threshold distance from an object ahead of the vehicle; if the distance between the vehicle and the object is within the threshold distance, engaging regenerative braking to reduce the speed of the vehicle; and if the distance between the vehicle and the object is above the threshold distance, preventing regenerative braking from being engaged to allow the vehicle to coast.

In another aspect of the disclosure, a vehicle is disclosed. The vehicle includes a distance sensor configured to detect a distance between the vehicle and an object in front of the vehicle; a pedal configured to increase the speed of the vehicle when pressed; a communication module configured to transmit signals from the distance sensor and the pedal to a processor; and a non-transitory storage configured to store instructions. When executed by the processor, the instructions cause the processor to perform a method including determining whether the vehicle is within a threshold distance from an object ahead of the vehicle; if the distance between the vehicle and the object is within the threshold distance, engaging regenerative braking to reduce the speed of the vehicle; and if the distance between the vehicle and the object is above the threshold distance, preventing regenerative braking from being engaged to allow the vehicle to coast.

### BRIEF DESCRIPTION OF THE DRAWINGS

FIG. 1 illustrates an exemplary system block diagram of vehicle control system, according to embodiments of the disclosure.

FIG. 2 illustrates the exemplary steps in the operation of the intelligent one-pedal driving system of FIG. 1, according to embodiments of the disclosure.

### DETAILED DESCRIPTION OF THE PREFERRED EMBODIMENTS

In the following description of preferred embodiments, reference is made to the accompanying drawings which form a part hereof, and in which it is shown by way of illustration specific embodiments, which can be practiced. It is to be understood that other embodiments can be used and structural changes can be made without departing from the scope of the embodiments of this disclosure.

Generally described, the present disclosure relates to an intelligent one-pedal driving system that is designed to work in tandem with an adaptive cruise control system or an Advanced Driver Assistance Systems (ADAS) of a vehicle to reduce or eliminate the abrupt deceleration typically experienced when using a conventional one-pedal-driving system. The intelligent one-pedal driving system can use inputs from a LIDAR, camera, and/or other sensors on the vehicle to automatically engage a coasting mode, in which the vehicle would maintain speed even when the accelerator pedal is released by the driver. Specifically, when the forward LIDAR, camera, and/or other sensors detect an object such as another vehicle, the intelligent one-pedal driving system can stay in a normal mode in which releasing the accelerator pedal would slow down and/or stop the vehicle as needed.

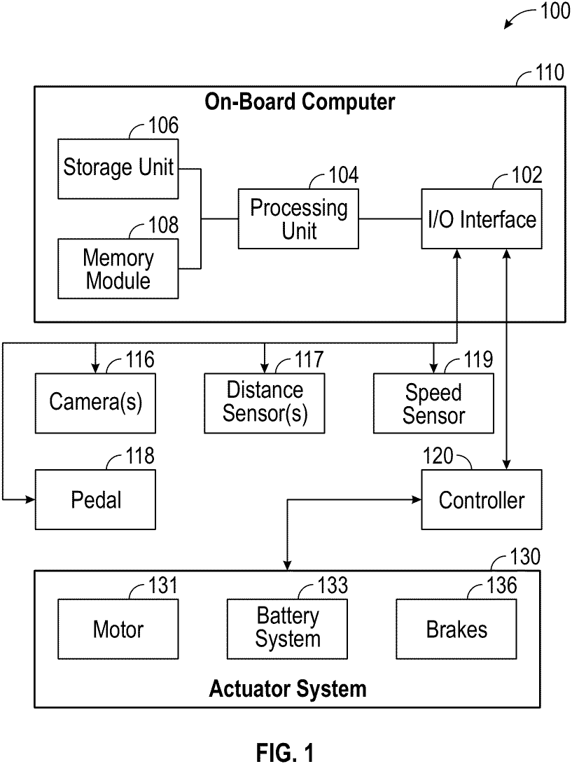

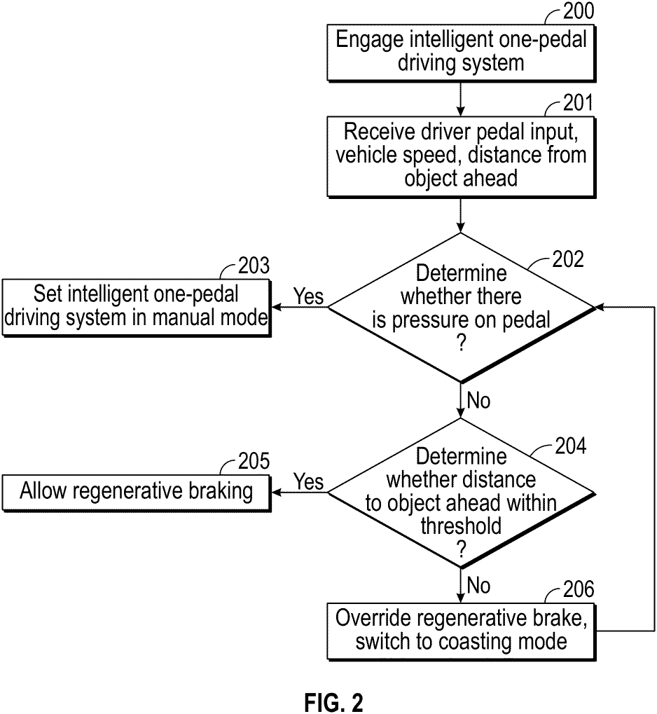

FIG. 1 illustrates an exemplary system block diagram of vehicle control system 100, according to examples of the disclosure. Vehicle control system 100 can perform any of the methods described below with reference to FIG. 2. System 100 can be incorporated into a vehicle of any body style, such as but not limited to, a sports car, a coupe, a sedan, a pick-up truck, a station wagon, a sports utility vehicle (SUV), a minivan, or a conversion van. The vehicle may be an electric vehicle, a fuel cell vehicle, a hybrid vehicle, or any other types of vehicles that are fitted with regenerative braking.

Vehicle control system 100 can include one or more cameras 106 capable of capturing image data (e.g., video data) of the vehicle’s surroundings. In one embodiment, the one or more cameras 106 can be front facing and capable of detecting objects such as other vehicles in front of the vehicle. Additionally or alternatively, vehicle control system 100 can also include one or more distance sensors 107 (e.g., radar, ultrasonic, and LIDAR) capable of detecting various characteristics of the vehicle’s surroundings. Additionally, vehicle control system 100 can include a speed sensor 109 for determining the speed of the vehicle. The camera(s) 106, distance sensor(s) 107, and speed sensor 109 can be part of the adaptive cruise control system or ADAS system of the vehicle.

Additionally, vehicle control system 100 can include a pedal 108 configured to receive input from the driver to control the movement of the vehicle. In one embodiment, the pedal 108 can be an accelerator pedal that, when pressed, causes the vehicle to accelerate or maintain speed. In a vehicle equipped with regenerative braking, the same pedal 108, when released, can cause the car to decelerate and eventually stop.

Vehicle control system 100 includes an on-board computer 110 that is operatively coupled to the cameras 116, distance sensors 117, speed sensor 119, and pedal 118. The on-board computer 110 is capable of receiving the image data from the cameras and/or outputs from the sensors 117, 119. The on-board computer 110 can also receive outputs from the pedal 118.

In accordance with one embodiment of the disclosure, the on-board computer 110 can be configured to engage, control, and/or disengage the intelligent one-pedal driving system in response to the data/outputs from the camera(s) 116, sensor(s) 117, speed sensor 119, and pedal 118. Additionally, the on-board computer 110 is also capable of setting the vehicle in different operation modes. The different operation modes can include a normal driving mode, in which the vehicle is largely operated manually by the driver, and one of more different levels of autonomous driving modes, in which, the vehicle can provide various driving assistances to the driver including some of the features described in the embodiments of this disclosure.

In some examples, the on-board computer 110 may include, among other modules (not illustrated in FIG. 1), an I/O interface 102, a physical processing unit 104, a storage unit 106, and a memory module 108. The on-board computer 110 may be specialized to perform the methods and steps described below.

I/O interface 102 may be configured for two-way communication between on-board computer 110 and various components of vehicle control system 100, such as camera(s) 116, distance sensor(s) 117, pedal 118, speed sensor 119, as well as a controller 120. I/O interface 102 may send and receive the data between each of the devices via communication cables, wireless networks, or other communication mediums.

Processing unit 104 may be configured to receive signals and process the signals to determine a plurality of conditions of the operation of the vehicle, for example, through controller 120. For example, processing unit 104 can receive image/video data from camera(s) 116 and/or sensor data from distance sensor(s) 117. The processing unit 104 can determine based on the image/video and sensor data whether there is another object (e.g., vehicle) ahead by analyzing the image/video and sensor data. In some embodiments, the processing unit 104 can determine a distance to the object. Processing unit 104 can also receive pedal modulation data from pedal 118. The pedal modulation data can represent the amount of force being applied to the pedal 118. Additionally, processing unit 104 can also receive the speed of the vehicle from the speed sensor 119.

Processing unit 104 may also be configured to generate and transmit command signals, via I/O interface 102 to controller 120 in order to actuate the various actuator systems 130 of the vehicle control system 100 as described below.

Storage unit 106 and/or memory module 108 may be configured to store one or more computer programs that may be executed by on-board computer 110 to perform functions of system. For example, storage unit 106 and/or memory module 108 may be configured to process instructions to enable the intelligent one-pedal driving described herein. Storage unit 106 and/or memory module 108 may further be configured to store data useful for carrying out intelligent one-pedal driving described herein.

Vehicle control system 100 may also include a controller 120 connected to the on-board computer 110 and capable of controlling one or more aspects of vehicle operation, such as performing intelligent one-pedal driving operations using instructions from the onboard computer 110.

In some examples, the controller 120 is connected to one or more actuator systems 130 in the vehicle. The one or more actuator systems 130 can include, but are not limited to, a motor 131, battery system 133, and brakes 136. The on-board computer 110 can control, via controller 120, one or more of these actuator systems 130 during vehicle operation; for example, to control the speed of the vehicle when intelligent one-pedal driving is engaged, using the motor 131, battery system 133, and brakes 136.

FIG. 2 illustrates the exemplary steps in the operation of the intelligent one-pedal driving system of FIG. 1. When the intelligent one-pedal driving system of the vehicle is engaged (step 200), the on-board computer 110 of the vehicle can receive three inputs: driver pedal input, vehicle speed, and a distance between the vehicle and the vehicle (or another object) ahead (step 201). The driver pedal input can be based on the detected pressure exerted on pedal 118. The vehicle speed can be measured by, for example, the speed censor 119 and/or correspond to the speed indicated on the speedometer. The distance from the vehicle (or other object) ahead can be determined from image data captured by one or more cameras 116 of the vehicle and/or calculated based on data received from distance sensor(s) (e.g., LIDAR, radar) 117.

The on-board computer determines whether the driver pedal input indicates pressure on the pedal 118 (step 202). If the on-board computer 110 determines that there is detectable pressure on the pedal, the intelligent one-pedal driving system can be set in a manual mode, in which the speed of the vehicle is controlled based on the driver pedal input (step 203). This can be achieved by the on-board computer 110 sending control signals to the controller 120, which, in turn, can control the actuator systems 130 (motor 131, battery 133, and/or brakes 136, etc.) to operate the car in response to these signals.

If the driver pedal input indicates non-detectable pressure on the pedal 118, the on-board computer 110 can then determine whether the distance from the object ahead (e.g., another vehicle) is within a threshold distance (step 204). The threshold distance can be preset by the intelligent one-pedal driving system. The threshold distance can vary based on the speed of the vehicle to ensure that the vehicle can stop in time if the object ahead stops abruptly.

If the distance calculated based on the camera(s) 116 and/or distance sensor(s) 117 is within the threshold distance (i.e., there is insufficient distance between the vehicle and the object ahead), the intelligent one-pedal driving system can allow regenerative braking to take effect in response to detecting the driver releasing the pedal (step 205). Regenerating braking will slow down the vehicle to avoid getting too close the object ahead. In some embodiments, the on-board computer 110 can automatically engage adaptive cruise control to maintain a safe distance from the vehicle ahead.

The intelligent one-pedal driving system 100 described in this embodiment differs from conventional one-pedal driving when the on-board computer 110 determines that the distance calculated based on the camera and/or distance sensor outputs is above the threshold distance (i.e., there is sufficient distance between the vehicle and the object ahead). In that case, the intelligent one-pedal driving system can automatically override the normal one-pedal drive mode regenerative braking signal with a zero-torque command to let the vehicle continue in a coasting mode without being slowing down by regenerative braking (step 206). This can be achieved by the on-board computer 110 sending control signals to the controller 120, which, in turn, can control the actuator systems 130 (motor 131, battery 133, and/or brakes 136, etc.) not to engage regenerative braking.

In the coasting mode, the vehicle no longer consumes power from the high-voltage (HV) battery, but can benefit from the inertia to continue its motion. By not engaging regenerative braking when the driver takes his/her foot off the pedal, the occupant(s) of the car will not feel the abrupt shove and thrust typically caused by regenerative braking.

When the driver presses the pedal 118 again, the on-board computer 110 can switch from the coasting mode to manual mode to give control back to the driver (steps 202, 203).

Referring back to FIG. 1, all of the methods and tasks described herein may be performed and fully automated by the on-board computer 110. Processing unit 104 can include one or multiple processors that execute program instructions or modules stored in storage unit 106 and/or memory module 108. The storage unit 106 and/or the memory module 108 can be non-transitory computer-readable storage medium or device (e.g., solid state storage devices, disk drives, etc.). The various functions disclosed herein may be embodied in such program instructions or may be implemented in application-specific circuitry (e.g., ASICs) of the on-board computer 110.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC.

Although embodiments of this disclosure have been fully described with reference to the accompanying drawings, it is to be noted that various changes and modifications will become apparent to those skilled in the art. Such changes and modifications are to be understood as being included within the scope of embodiments of this disclosure as defined by the appended claims.

What is claimed is:

1. A computer-implemented method of operating a vehicle comprising:
receiving a first signal from a pedal indicating no pressure is exerted on the pedal, the pedal, when pressed, configured to provide a manual input to an operation of the vehicle;
determining whether the vehicle is within a threshold distance from an object ahead of the vehicle;
if the distance between the vehicle and the object is within the threshold distance, engaging regenerative braking to reduce the speed of the vehicle; and
if the distance between the vehicle and the object is above the threshold distance, preventing regenerative braking from being engaged to allow the vehicle to coast.

2. The computer-implemented method of claim 1, further comprising:
receiving a second signal from a distance sensor of the vehicle; and
calculating the distance between the object and the vehicle based on the second signal.

3. The computer-implemented method of claim 1, further comprising:
receiving image data from a camera of the vehicle; and
determining the distance between the object and the vehicle based on the image data.

4. The computer-implemented method of claim 1, further comprising:
receiving speed data from a speed sensor of the vehicle; and
determining the speed of the vehicle based on the speed data,
wherein the threshold distance is set based on the speed of the vehicle.

5. The computer-implemented method of claim 1, wherein engaging regenerative braking to reduce the speed of the vehicle comprises transmitting a third signal to a motor of the vehicle.

6. The computer-implemented method of claim 1, wherein preventing regenerative braking from being engaged comprises transmitting a zero-torque command to a motor of the vehicle.

7. The computer-implemented method of claim 1, wherein if the distance between the vehicle and the object is within the threshold distance, automatically engaging an adaptive cruise control of the vehicle.

8. A vehicle comprising:
a distance sensor configured to detect a distance between the vehicle and an object in front of the vehicle;
a pedal configured to increase the speed of the vehicle when pressed;
a communication module configured to transmit signals from the distance sensor and the pedal to a processor; and
a non-transitory storage configured to store instructions, which when executed by the processor, cause the processor to perform a method comprising:
determining whether the vehicle is within a threshold distance from an object ahead of the vehicle;
if the distance between the vehicle and the object is within the threshold distance, engaging regenerative braking to reduce the speed of the vehicle; and
if the distance between the vehicle and the object is above the threshold distance, preventing regenerative braking from being engaged to allow the vehicle to coast.

9. The vehicle of claim 8, wherein the method further comprises:
receiving image data from a camera of the vehicle; and
determining the distance between the object and the vehicle based on the image data.

10. The vehicle of claim 8, wherein the method further comprises:
receiving speed data from a speed sensor of the vehicle; and
determining the speed of the vehicle based on the speed data.

11. The vehicle of claim 10, wherein the threshold distance is set based on the speed of the vehicle.

12. The vehicle of claim 8, wherein engaging regenerative braking to reduce the speed of the vehicle comprises transmitting a third signal to a motor of the vehicle.

13. The vehicle of claim 8, wherein preventing regenerative braking from being engaged comprises transmitting a zero-torque command to a motor of the vehicle.

14. The vehicle of claim 8, wherein if the distance between the vehicle and the object is within the threshold distance, automatically engaging an adaptive cruise control of the vehicle.

15. The vehicle of claim 8, further comprising:
a controller in communication with the processor;
a motor and brakes, both in communication with the controller;
wherein the method further comprises the processor transmitting a control signal to the controller; and the controller controls the motor and brakes in response to the control signal.
